(19) United States
(12) Patent Application Publication
(10) Pub. No.: US 2011/0008594 A1
(43) Pub. Date: Jan. 13, 2011

(54) CONCRETE TEMPLATE AND METHOD OF USE

(76) Inventors: Lee A. Shaw, Newport Beach, CA (US); Ronald D. Shaw, Corona Del Mar, CA (US)

Correspondence Address: STETINA BRUNDA GARRED & BRUCKER, 75 ENTERPRISE, SUITE 250, ALISO VIEJO, CA, 92656, US

(21) Appl. No.: 12/498,974

(22) Filed: Jul. 7, 2009

(51) Int. Cl. B32B 3/10; B28B 11/08

(52) U.S. Cl. 428/206; 264/293

(57) ABSTRACT

A method of transferring a design to an uncured concrete surface of a poured concrete mixture is provided. The method comprises the steps of: (a) placing a releasable template onto the surface to define exposed and covered regions; (b) manipulating the exposed regions corresponding to the design; (c) removing the template to reveal the covered regions; and (d) finishing the surface. The template may be variously configured and may incorporate positive and negative portions, which may be alternatively utilized to transfer the design to respective positive and negative regions of the surface. The template may preferably be fabricated from visquene, craft paper, or other suitable material. In addition, implementations of the present invention may be utilized with surface seeded exposed aggregate, troweling, or other surface finishing processes.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to concrete products, and more particularly, to a method of transferring a design to an uncured concrete surface of a concrete mixture utilizing a releasable template.

As is well known in the building and construction trade, concrete is extensively utilized as a building material for industrial, commercial and residential applications. Due to its durability, water resistance, and cost economy, concrete has gained wide spread use in flooring applications. With this wide spread use, the public is currently demanding variations in color, surface texture and overall appearance of concrete so that the concrete possesses improved aesthetics similar to more conventional and costly flooring surfaces such as marble, stone and granite.

In order to meet this demand, the concrete trade has developed various coloring and surface finishing techniques to enhance the aesthetics of concrete. Examples of such finishing techniques include salt finish, multiple broom finish, form press finish (e.g. stamped concrete), and exposed aggregate finish.

With particular regard to exposed aggregate finishes, one of two different production methods or techniques are typically utilized to form the same. The first is the “integrally exposed aggregate” method, which is the more conventional of the two techniques. The integrally exposed aggregate method entails washing or removing surface cement and fines from the concrete while the concrete surface is still plastic (i.e., prior to full curing) such that the aggregate (which is normally rock or gravel) is left exposed on the surface of the concrete. Due to the fact that the concrete aggregate is relatively large in size (i.e., approximately one-half inch to one inch in mean diameter), as well as the fact that the washing process is not uniform in nature, the resultant concrete surface produced via the integrally exposed aggregate method is often extremely rough and jagged. This characteristic limits wide spread use of the integrally exposed aggregate method in flooring applications. Further, the rough and jagged appearance also fails to create the aesthetic appearance of stone or marble that is desired.

The second method is the “surface seeded exposed” method, which has recently been introduced into the trade. In this particular method, subsequent to pouring the concrete, rock or gravel aggregate is scattered (i.e. broadcasted or seeded) over the top surface of the concrete and subsequently troweled into the same. As the concrete cures, the aggregate becomes adhered to the top surface of the concrete and is thus exposed. Although various sizes of aggregate can be broadcast over the top surface of the concrete in this method, such aggregate is normally of about three-eighths inch diameter or greater in size, and has sheared or jagged edges. The size and shape of the aggregate allows it to be worked into the top surface of the concrete and adequately adhered thereto. However, although the resultant concrete surface produced through the surface seeded exposed aggregate method is flatter than the surface produced through the integrally exposed aggregate method, neither surface is free of irregularities, and both surfaces still posses an extremely rough surface finishes which limit their wide spread use in flooring applications. In particular, neither method produces a surface finish comparable to that of marble, stone, or granite.

In order to overcome the above-mentioned deficiencies of the prior art, methods have been developed to enhance the surface finish of concrete by reducing the size of the aggregate exposed on the surface of the concrete. However, as the aggregate decreases in size, other challenges develop due to the alkali-silica reaction (ASR). ASR is a chemical process through which alkalis from cement and silica from aggregate, combine to form a gel that expands in the presence of moisture and causes cracking in concrete and disrupts the adhesion of aggregate to the top surface of the concrete.

In response the challenges that ASR presents, other methods have been developed to obtain sufficient surface flatness while substantially eliminating the effects of ASR. In particular, several of these methods are described in Applicant's U.S. Pat. Nos. 4,748,788, 6,016,635, and 6,033,146, the contents of which are incorporated herein by reference. Applicant's techniques as described in the above-mentioned patents overcame many of the deficiencies of the prior art and produced improved surface finishes on surface seeded exposed aggregate concrete. In particular, the concrete resultant from practice of the above-mentioned patents exhibits an extremely flat exposed aggregate surface suitable for extremely high traffic flooring applications. However, the surface seeded exposed aggregate method has only hitherto been refined to produce surfaces that assimilate stone, marble, or granite. No process has been developed that makes it possible to combine multiple variations of aggregate, designs, or textural effects onto a single cement surface. Typically, such modifications have been limited to the use of concrete stamps or concrete saws.

Therefore, there is a need in the art for a surface seeded exposed aggregate method and product that facilitates the creation of surfaces which incorporate various design patterns and multiple textural effects. Further, there is a need in the art for a method of producing designs on concrete that is simple and effective. Indeed, there is a need in the art for a surface seeded exposed aggregate method that allows flexibility in creating multiple unique and separate designs in a single concrete surface, shielding certain areas while allowing other areas to be finished.

### BRIEF SUMMARY

According to a preferred embodiment of the present invention, a method of transferring a design to an uncured concrete surface of a poured concrete mixture is provided. The method comprises: (a) placing a releasable template onto the surface to define exposed and covered regions; (b) manipulating the exposed regions corresponding to the design; (c) removing the template to reveal the covered regions; and (d) finishing the surface. The releasable template may be fabricated from visquene, craft paper, or other materials known in the art. In addition, the releasable template may be precut corresponding to the exposed and covered regions.

After placing the template onto the surface, the method may include the step of troweling the template into the surface to secure the template thereto. Additionally, the exposed regions may be manipulated by broadcasting aggregate onto the surface at the exposed regions thereof and finishing the surface seeding of the aggregate corresponding to the exposed regions. Prior to broadcasting the aggregate, the surface may be finished to dispose a quantity of cement/fines paste derived from the concrete mixture at the surface thereof. Further, subsequent to broadcasting the aggregate, the aggregate may be mixed into the cement/fines paste. The step of manipulating the exposed regions may also include manipulating the shape of the concrete surface of the exposed regions. In this regard, a troweling device may be utilized to manipulate the shape of the concrete surface. Finally, in accordance with another aspect of the present invention, the surface may be finished by applying a surface retarder to the surface and massaging the surface retarder into the surface.

According to another aspect of the present invention, a surface seeded exposed particulate concrete product formed by the methods herein disclosed is also provided. The concrete product may be variously configured and prepared, as is apparent to one of skill in the art given the disclosure provided herein.

In accordance with another implementation of the present invention, a method of transferring a design to an uncured concrete surface of a concrete mixture utilizing a releasable template, the template including positive and negative portions is provided. The method comprises: (a) transferring the design corresponding to the positive portion through the steps of: (i) placing the positive portion onto the surface, the positive portion defining positive regions on the surface; (ii) manipulating the positive regions thereof; and (iii) removing the positive portion from the surface; and (b) finishing the surface. The releasable template may be fabricated from visquene, craft paper, or other materials known in the art.

After placing the template onto the surface, the method may include the step of troweling the template into the surface to secure the template thereto. After transferring the design corresponding to the positive portion of the template, the method may also include transferring the design corresponding to the negative portion through the steps of: (a) placing the negative portion onto the surface, the negative portion defining negative regions on the surface; (b) manipulating the negative regions thereof; and (c) removing the negative portion.

The releasable template may be precut corresponding to the positive and negative regions. Further, the manipulating step of the method may include (a) finishing the surface to dispose a quantity of cement/fines paste derived from the concrete mixture at the surface thereof; (b) broadcasting aggregate onto the surface corresponding to at least one of the positive and negative regions thereof, and (c) mixing the aggregate into the cement/fines paste. Indeed, at least one of the manipulating steps may include manipulating of the concrete surface utilizing a troweling device and corresponding to at least one of the positive and negative regions. Finally, in accordance with another aspect of the present invention, the surface may be finished by applying a surface retarder to the surface and massaging the surface retarder into the surface.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a method illustrating various steps which may be performed in transferring a design to an uncured concrete surface of a concrete mixture utilizing a releasable template in accordance with an embodiment of the present invention;

FIG. 2A is a perspective view of the template being placed upon the surface in accordance with an embodiment of the present invention;

FIG. 2B is a perspective view of the surface in which a region thereof has been manipulated in accordance with an aspect of the present invention;

FIG. 2C is a perspective view of the template being removed from the surface after a region thereof has been manipulated in accordance with an aspect of the present invention;

FIG. 2D is a perspective view of a negative portion of the template being placed upon the surface in preparation for manipulation of a negative region of the surface in accordance with an embodiment of the present invention;

FIG. 2E is a perspective view of the surface being troweled to incorporate the design in accordance with an embodiment of the present invention;

FIG. 3A is a perspective view of the template including positive and negative portions placed upon the surface in accordance with an embodiment of the present invention;

FIG. 3B is a perspective view of the positive portion placed upon the surface to define a positive region which has been manipulated in accordance with an aspect of the present invention;

FIG. 3C is a perspective view of the negative portion placed upon the surface to define a negative region which has been manipulated in accordance with an aspect of the present invention; and

FIG. 3D is a perspective view of the surface wherein the positive and negative regions are exposed for collective manipulation thereof in accordance with an embodiment of the present invention.

### DETAILED DESCRIPTION

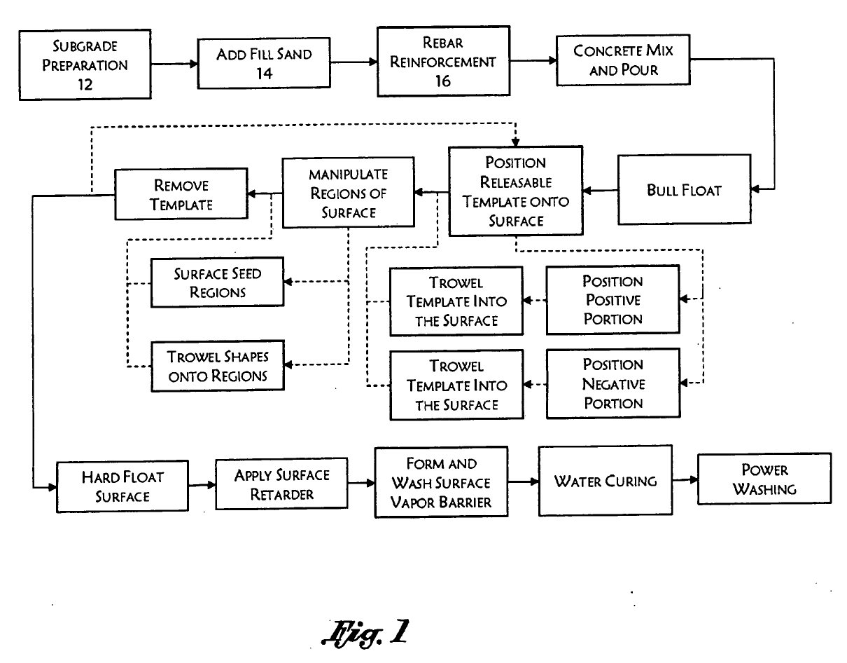

Referring now to the drawings wherein the showings are for purposes of illustrating the preferred embodiments of the invention only, and not for purposes of limiting the same, FIG. 1 is a block diagram illustrating a method of transferring a design 26 to an uncured surface of a poured concrete mixture 10. An implementation of the present invention may be performed after properly preparing a subgrade 12, which may be prepared in a variety of ways, utilizing a variety of tools, materials, and methods. As described in further detail below, implementations of the present invention provide for the combination of multiple designs or effects onto a single cement surface. In accordance with one implementation, a surface seeded exposed aggregate method is provided that facilitates the creation of surfaces which incorporate various design patterns, colors, and multiple textural effects. Other modifications and combinations are also provided and may be apparent to one of skill in the art.

One such conventional mode of preparation involves preparing the subgrade 12 to a desired elevation and blade and to compact the subgrade 12 preferably to ninety percent (90%) compaction. Subsequent to this preparation, the subgrade 12 is covered with a layer of clean, moist fill sand 14 which is preferably maintained at a minimum four (4) inch layer thickness. Although the fill sand 14 is not absolutely necessary, it is highly desirable to control the hydration process of the concrete. In order to increase the resultant strength of the concrete and to reduce subsequent cracking of the same, reinforcement members 16 such as a wire mesh or rebar may be positioned upon the layer of fill sand 14. The layer which includes the fill sand 14 and the reinforcement members 16 is often collectively referred to as the subgrade 12.

The concrete mixture 10 may be poured over the subgrade 12 such that the reinforcement members 16 are encapsulated within the concrete mixture 10. The concrete mixture 10 may be poured to approximately a three and one half (3½) inch to four (4) inch thickness. Although variations in the concrete mixture 10 are contemplated, a preferred concrete mixture 10 comprises seventy percent (70%) sand and thirty percent (30%) ⅜ inch mean diameter aggregate combined with six sack cement (2,000 pounds per square inch) or seven sack cement (2,000 pounds per square inch). Dependent on individual tastes, various color mixtures can be added to the concrete mixture 10.

After the concrete mixture 10 has been poured, the concrete mixture 10 is preferably screeded to a desired level plan or grade. The screeding of the concrete mixture 10 results in the same defining a generally level or planar upper surface. The concrete mixture 10 is preferably not tamped as is conventional in the art. In preferred implementations, tamping should be avoided so as not to bring up too much cement/fines in the concrete mixture 10 which would be prohibited for subsequent surface seeding of the exposed aggregate 24 thereupon. Rather, subsequent to screeding, the surface of the concrete mixture 10 is surfaced or finished to dispose a quantity of the cement/fines paste derived from the concrete mixture 10 to the surface thereof. This finishing is preferably done utilizing a bull float. The bull float is typically characterized by possessing an extremely smooth or polished surface which, in addition to bringing up the appropriate amount of cement/fines paste for the subsequent manipulative step, also tends to seal the surface of the concrete mixture 10. It is contemplated that this initial finishing step may be also completed through the use of a vibrating bull float, such as a vibrating magnesium bull float or a vibrating aluminum bull float. The preferred bull float is sold under the trademark HAL200 by the Lievers Holland Colo.

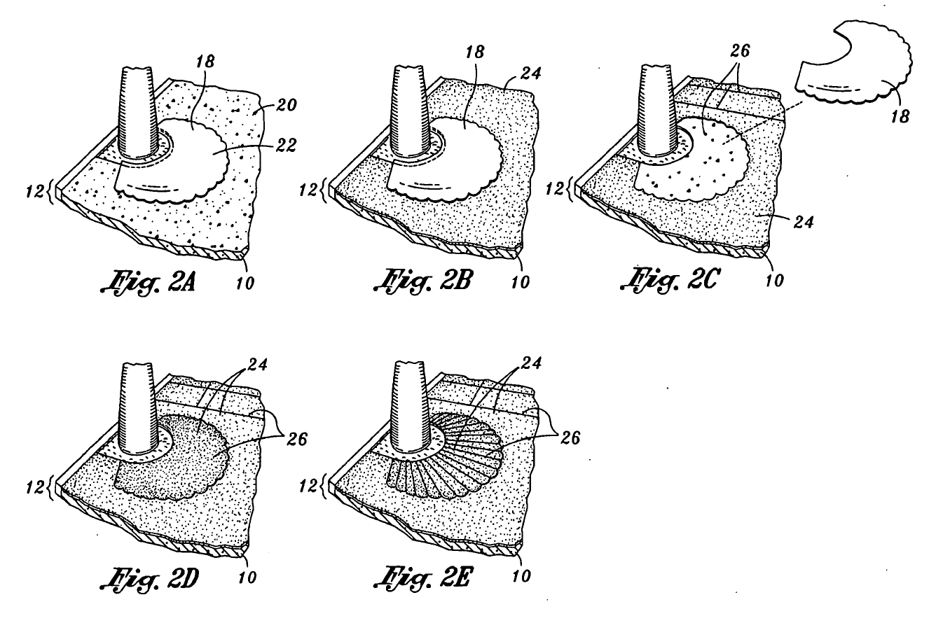

As shown in FIG. 2A, according to an aspect of the present invention, a releasable template 18 may be placed onto the surface of the poured concrete mixture 10. The template 18 may be fabricated from visquene, craft paper, or other suitable materials. The template 18 defines exposed and covered regions 22, and when placed on the surface, protects the surface in the covered regions 22 from alteration and leaves the exposed regions 20 open to facilitate manipulation or finishing processes to be performed therein. As shown in FIGS. 2A-2E, the template 18 may be configured in accordance with a decorative design 26, as preferred by a user. In this regard, the shape and configuration of the exposed and covered regions 20, 22 is theoretically limitless, but should take into account any of the finishing processes that are to be performed in the respective exposed and covered regions 20, 22, and any limitations imposed thereby. Such planning and development may be variously performed by one of skill in the art.

Additionally, after placing the template 18 onto the surface, it is contemplated that the template 18 may be troweled into the surface in order to better secure the template 18 to the surface during subsequent steps. In this regard, although troweling is a preferred manner of securing the template 18 to the surface due to the facility of such procedure, other methods and procedures may be implemented in order to ensure that the template 18 retains its position and shape during subsequent steps. Such alterations and manipulations of embodiments of the present invention may be performed by one having skill in the art.

After placing the template 18 onto the surface, as illustrated in FIG. 2B, the exposed regions 20 corresponding to the design 26 may be manipulated according to a given finishing process or operation. Although numerous finishing processes may be performed on the exposed regions 20, preferred embodiments of the present invention may utilize surface seeded exposed aggregate 24. Thus, aggregate 24 may be broadcast onto the surface at the exposed regions 20 and those exposed regions 20 may be finished according to various finishing steps in relation to surface seeding of the aggregate 24. For example, when the exposed regions 20 are still plastic, small size aggregate 24 may be broadcast over the exposed regions 20. The aggregate 24 may include silica sands, coarse sands, brass beads, organic materials, metals, fine sand, composite materials, or combinations thereof. In broadcasting the aggregate 24 onto the surface, it is contemplated that various patterns or visual effects may be created thereby, especially given the flexibility of utilizing several types of aggregate 24. It is contemplated that certain tools may be utilized to perform the broadcasting steps, such as pneumatic equipment or other spraying/spreading equipment.

After the aggregate 24 is broadcast upon the exposed regions 20, the aggregate 24 is preferably mixed or worked into the exposed regions 20 of the surface, and more particularly, is preferably mixed into the cement/fine paste of the surface. In implementations of the present invention, this step may be utilized to further enhance the physical placement of the aggregate 24 on the surface. It is contemplated that this step may be variously performed in order to create various effects such as simulating natural stone or other materials. This may be accomplished utilizing a power trowel. However, it is contemplated that the mixing may be accomplished utilizing other devices known in the art. This mixing of the aggregate 24 with the cement/fine paste at the surface is also critical to the process of the present invention because it ensures that the aggregate 24 is fully embedded into the cement/fine paste and thus thoroughly adhered or bonded to the surface of the concrete mixture 10 upon resultant curing.

After manipulating the exposed regions 20 corresponding to the design 26, the template 18 may be removed to reveal the covered regions 22, as illustrated in FIG. 2C. At this point, the covered regions 22 may then likewise be manipulated according to design 26 requirements, as shown in FIG. 2D. This manipulation may alter the exposed regions 20 together with the covered regions 22, or alternatively, may alter only the covered regions 22.

In addition, it is contemplated that the exposed regions 20 and/or the covered regions 22 may also be manipulated utilizing a troweling device as shown in FIG. 2E. The troweling device may be a trowel, a stamp, or other suitable tool. Thus, utilizing the troweling device, various designs 26 or patterns may be transferred to the exposed regions 20 of the surface utilizing the skill, taste, and design 26 as required by the user. Preferably, such manipulation of the surface utilizing the troweling device is performed when the concrete has partially set, but prior to full curing.

After the design 26 has been transferred to the exposed regions 20 (and perhaps the covered regions 22) of the surface, the entire surface (including the exposed regions 20 and the covered regions 22) may then be finished with a power trowel to properly level and finish the surface. Subsequent finishing steps, as detailed below, may then be performed.

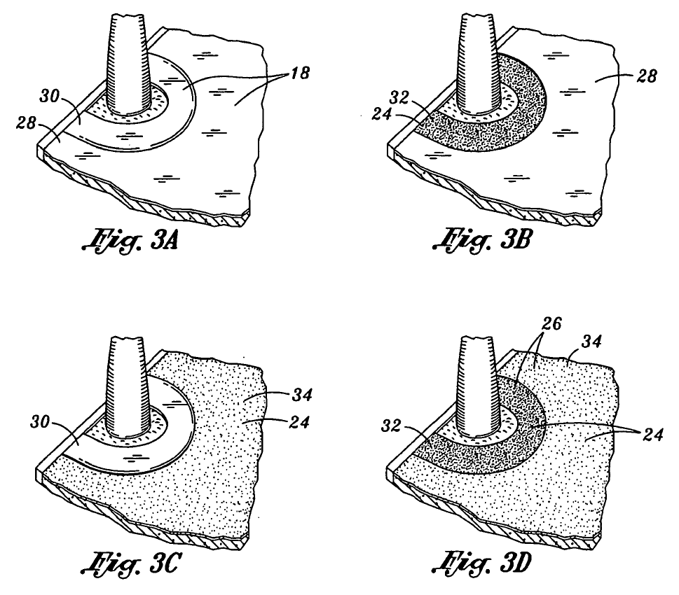

According to another embodiment of the present invention, as illustrated in FIGS. 3A-3D, it is contemplated that the releasable template 18 may be divided into positive and negative portions 28, 30, which respectively define positive and negative regions 32, 34 when placed onto the surface. Referring to FIG. 3B, the positive portion 28 may be placed onto the surface to protect the covered regions 22 of the surface and to leave exposed the positive regions 32 of the surface for facilitating the transfer of the design 26 to the positive regions 32, in a manner as discussed above. After finishing the positive regions 32, the positive portion 28 may be removed from the surface. In addition, after removing the positive portion 28 from the surface, the negative portion 30 may then be placed onto the surface, as shown in FIG. 3C, thereby exposing negative regions 34 of the surface. Thereafter, the negative regions 34 of the surface may be finished according to at least one of a variety of finishing processes described above, such as with surface seeded exposed aggregate 24, or otherwise known in the art. Subsequent to completion of the negative regions 34 and transferal of the design 26 thereto, the negative portion 30 of the template 18 may be removed from the surface, as shown in FIG. 3D. At this point, both the positive and the negative regions 32, 34 of the surface may be finished utilizing the finishing steps described below.

Referring again to FIG. 1, after transferring the design 26 to the surface, a chemical surface retarder may be sprayed upon the surface to uniformly cover the same. The chemical retarder slows down the hydration process of the concrete mixture 10. The application of the surface retarder to the surface may be followed by the step of finishing the surface of the concrete mixture 10 with the power trowel, for example, to massage the surface retarder into the cement/fines paste having the aggregate 24 mixed therein. This finishing step preferably results in the penetration of the surface retarder into the cement/fines paste at a distance below the maximum depth of the aggregate 24, which may be at least approximately ⅜ inch in some instances. Advantageously, this particular finishing step may eliminate hard spots in the resultant concrete by facilitating a full mix of the retarder and the cement/fines paste. The power trowel, preferably used in relation to both this and the previously mentioned step, finishes the surface of the concrete mixture 10 in a generally circular motion. Although various conventional surface retarders may be utilized, one superior surface retarder is designated as SPEC AE manufactured by E. L. Moore Co. of Costa Mesa, Calif.

As shown in FIG. 1, subsequent to the surface retarder being massaged into the cement/fine paste, a vapor barrier may be preferably formed on the surface of the concrete mixture 10. In the preferred embodiment, the formation of the vapor barrier is facilitated by the application of a liquid chemical evaporation reducer to the exposed surface of the concrete mixture 10. A preferred evaporation reducer is sold under the trademark CONFILM by the Concrete Tide Co. of Compton, Calif. An alternative vapor barrier may be formed by covering the surface with four (4) or six (6) millimeters of visquene. The vapor barrier is maintained upon the surface of the concrete mixture 10 for a prescribed period of time which may range from approximately two (2) to twenty-four (24) hours.

After the vapor barrier has remained upon the surface for a prescribed period of time, the surface of the concrete mixture 10 may be washed with water to remove any surface films therefrom. In this washing procedure, it may be preferable to lightly brush the surface with a bristle brush. This may be done in order to enhance or alter the design 26. The washing step, as described herein, may be done without excessive dislodgement and loss of the aggregate 24 due to the full mixture of the retarder and cement/fine paste performed during the power troweling of the surface. Additionally, the application of the liquid evaporation reducer to the surface may also reduce the rate of the evaporation of moisture from the surface and increase the ease at which the excess cement/fine paste and residual surface retarder are washed from the surface.

As illustrated in FIG. 1, subsequent to washing, the concrete mixture 10 may be cured utilizing water alone, as opposed to chemical curing agents in order to avoid staining of the surface. Such water curing may typically be facilitated through the use of a conventional fogger or soaker hose. After a prescribed period of time (e.g., 30 days after initiating the curing process) any surface residue present on the surface is removed by conventional power washing with a ninety percent (90%) steam and ten percent (10%) muriatic acid mixture which is applied by a power washer via a high pressure nozzle.

The resultant surface exhibits an appearance of various textures and patterns according to the complexity of the design 26. Further, as an extremely flat surface, even when surface seeded exposed aggregate 24 is utilized, it is also suitable for high pedestrian traffic. As described above, various modifications in the color, size, texture, and other characteristics of the aggregate 24 may be modified in order to produce numerous designs 26.

The above description is given by way of example, and not limitation. Given the above disclosure, one skilled in the art could devise variations that are within the scope of the invention disclosed herein, including various ways of creating different textures, colors, patterns, types of stone, etc. Further, the various features of the embodiments disclosed herein can be used alone, or in varying combinations with each other and are not intended to be limited to the specific combination described herein. Thus, the scope of the claims is not to be limited by the illustrated embodiments.

1. A method of transferring a design to an uncured concrete surface of an uncured concrete mixture, the method comprising:
a) pouring the uncured concrete mixture which defines the uncured concrete surface;
b) placing a releasable template onto the uncured concrete surface to temporarily define exposed and covered regions of the uncured concrete surface of the uncured concrete mixture;
c) broadcasting a quantity of a first aggregate upon the exposed region of the uncured concrete surface;
d) broadcasting a quantity of a second aggregate upon the exposed region of the uncured concrete surface;
e) mixing the first aggregate and the second aggregate into the exposed region of the uncured concrete surface, the first aggregate and the second aggregate mixture simulating characteristics of quarried stone when the exposed surface is cured; and
f) removing the template from the uncured concrete surface to reveal the covered region.

2. The method of claim 1 wherein the releasable template is fabricated from visquene.

3. The method of claim 1 wherein the releasable template is fabricated from craft paper.

4. The method of claim 1 wherein the releasable template is precut corresponding to the exposed and covered regions.

5. The method of claim 1 further including the step of troweling the template into the surface to secure the template thereto.

6. (canceled)

7. The method of claim 1 further including:
prior to broadcasting the first aggregate and the second aggregate, finishing the uncured concrete surface to dispose a quantity of cement/fines paste derived from the concrete mixture at the surface thereof
b).

8. The method of claim 1 further comprising the step of manipulating the shape of the concrete surface of the exposed regions.

9. The method of claim 8 wherein a troweling device is utilized to manipulate the shape of the concrete surface.

10. The method of claim 1 further including:
a) applying a surface retarder to the uncured concrete surface; and
b) massaging the surface retarder into the uncured concrete surface.

11. A surface seeded exposed particulate concrete product formed by the method of claim 1.

12. A method of transferring a design to an uncured concrete surface of a concrete mixture utilizing a releasable template, the template including positive and negative portions corresponding to the design, the method comprising:
a) transferring the design corresponding to the positive portion onto a positive region through the steps of:
i) temporarily placing the positive portion onto the uncured concrete surface, the positive portion defining the positive region on the uncured concrete surface;
ii) broadcasting a quantity of a first aggregate upon the exposed region of the uncured concrete surface;
iii) broadcasting a quantity of a second aggregate upon the exposed region of the uncured concrete surface;
iv) mixing the first aggregate and the second aggregate into the exposed region of the uncured concrete surface, the first aggregate and the second aggregate mixture simulating characteristics of quarried stone when the exposed surface is cured; and
v) removing the positive portion from the surface; and
b) finishing the surface.

13. The method of claim 12 wherein the releasable template is fabricated from visquene.

14. (canceled)

15. The method of claim 12 further including the step of troweling the template into the surface to secure the template thereto.

16. The method of claim 12 further including the step of transferring the design corresponding to the negative portion through the steps of:
a) placing the negative portion onto the surface, the negative portion defining negative regions on the surface;
b) manipulating the negative regions thereof; and
c) removing the negative portion.

17. The method of claim 16 wherein the releasable template is precut corresponding to the positive and negative regions.

18. The method of claim 16 further comprising the step of:
finishing the surface to dispose a quantity of cement/fines paste derived from the concrete mixture at the surface thereof
c).

19. The method of claim 16 wherein at least one of the manipulating steps includes manipulating of the concrete surface utilizing a troweling device and corresponding to at least one of the positive and negative regions.

20. The method of claim 12 wherein step (b) further includes:
a) applying a surface retarder to the surface; and
b) massaging the surface retarder into the surface.

21. The method of claim 1, wherein the first aggregate is fine sand and the second aggregate is a material other than fine sand.

22. A method of transferring a design to an uncured concrete surface of an uncured concrete mixture, the method comprising:
a) pouring the uncured concrete mixture which defines the uncured concrete surface;
b) placing a releasable template onto the uncured concrete surface to temporarily define exposed and covered regions of the uncured concrete surface of the uncured concrete mixture;
c) broadcasting a quantity of a first aggregate upon the exposed region of the uncured concrete surface; and
d) mixing the first aggregate into the exposed region of the uncured concrete surface, the first aggregate simulating characteristics of quarried stone when the exposed surface is cured.
